(19) United States
(12) Patent Application Publication
(10) Pub. No.: US 2026/0177176 A1
(43) Pub. Date: Jun. 25, 2026

(54) CONNECTOR SYSTEM

(71) Applicant: Eaton Intelligent Power Limited, Dublin 4 (IE)

(72) Inventors: Jochen Meidlein, Munich (DE); Dipak Balaso Ranaware, Pune (IN); Nipen Mukeshbhai Khirsaria, Pune (IN); Jason C. Gauss, Jackson, MI (US)

(73) Assignee: Eaton Intelligent Power Limited, Dublin 4 (IE)

(21) Appl. No.: 19/424,552

(22) Filed: Dec. 18, 2025

(30) Foreign Application Priority Data
Dec. 20, 2024 (IN) 202411101215

(51) Int. Cl. F16L 37/113; F16L 37/36

(52) U.S. Cl. CPC F16L 37/113; F16L 37/36

(57) ABSTRACT

A quick disconnect connector system includes a first plug configured to mate with a second plug. The first plug and second plugs first secure together through engagement of one or more retainers with a channel. Each retainer is shaped to facilitate sliding of the retainer relative to the threads without catching while still allowing the retainer to securely engage the channel of the second plug. Example retainers have a tapered shape. An example retainer has a trapezoidal shape. In certain examples, a tapered mounting station for each retainer is configured to facilitate radial movement of the retainer.

### CROSS-REFERENCE TO RELATED APPLICATIONS

This application claims the benefit of Indian Provisional Application No. 202411101215, filed Dec. 20, 2024, titled “Connector System,” the disclosure of which is hereby incorporated herein by reference in its entirety.

### BACKGROUND

A quick disconnect coupling can include a first connector and a second connector. The first connector defines a fluid passageway. A first valve is movable between open and closed positions to control flow through the fluid passageway of the first connector. The second connector also defines a fluid passageway. A second valve is movable between open and closed positions to control flow through the fluid passageway of the second connector. The second connector is removably connectable to the first connector such that, when connected, the passageways are placed in fluid communication with each other. The first and second valves are operable between the open and closed positions to selectively place the fluid passageways of the first and second parts in fluid communication with each other. To mitigate leakage, the first and second connectors are configured to mechanically attach together to maintain coupling until both valves have been closed.

### SUMMARY

In accordance with certain aspects of the disclosure, a connector system includes a first connector and a retainer. The first connector includes an inner body surrounded by an outer nut. The outer nut is movable relative to the inner body along a longitudinal axis of the first connector. The outer nut has internal threading. The internal threading defines a circumferential groove at an intermediate location along the internal threading. The inner body defines a mounting station. The retainer is disposed at the mounting station of the inner body of the first connector. The retainer is configured to move radially relative to the inner body of the first connector between a locking position and a releasing position. The retainer is held in the locking position by the internal threading of the outer nut. The groove along the internal threading accommodates movement of the retainer to the releasing position. The retainer has a non-uniform transverse cross-section.

In certain examples, an inner surface of the retainer is more narrowly contoured than an outer surface.

In certain examples, the retainer has a tapered shape. In an example, the retainer has a trapezoidal traverse cross-sectional shape.

In some examples, the outer surface is planar. In other examples, the outer surface is convex. In certain examples, corners of the outer surface are rounded.

In accordance with other aspects of the disclosure, a quick disconnect connector system includes a first connector including an inner body extending along a longitudinal axis. The inner body defines a mounting station. The first connector also includes an outer nut extending about the inner body. The outer nut defines a groove. The inner body is movable relative to the outer nut along the longitudinal axis between an initial position, a transition position, and an operation position. The mounting station is aligned with the groove when the inner body is disposed in the transition position. The mounting station is disposed to a first side of the groove when the inner body is disposed in the initial position. The mounting station is disposed to an opposite, second side of the groove when the inner body is disposed in the operation position. The mounting station defines an aperture extending radially away from the longitudinal axis from a first open end to a second open end. The second open end is larger than the first open end.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an axial cross-section of a connector system including a first connector (e.g., female plug) configured to mate with a second connector (e.g., a male plug), the female plug carrying one or more retainers, the first and second plug connector shown spaced from each other for ease in viewing.

FIG. 2 is a perspective view of the axial cross-section of the first connector of FIG. 1.

FIG. 3 is an axial cross-section of an example inner body suitable for use in the first connector of FIG. 1.

FIG. 4 is an enlarged view of a portion of FIG. 3.

FIG. 5 is a perspective view of an example retainer suitable for use in the first connector of FIG. 1.

FIG. 6 is a side elevational view of the retainer of FIG. 5.

FIG. 7 is a transverse cross-section of the retainer of FIG. 5 taken along the 7-7 line of FIG. 6.

FIG. 8 shows the retainer disposed in the releasing position relative to the mounting station and the second connector.

FIG. 9 is an axial cross-section of the first and second connectors assembled together.

FIG. 10 is an enlarged view of a portion of FIG. 9.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

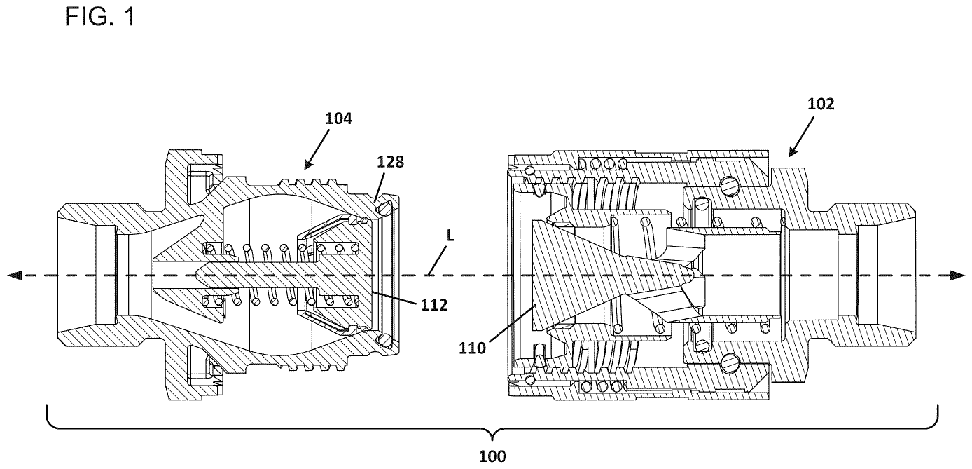

FIG. 1 illustrates an example quick disconnect connector system 100 including a first connector 102 and a second connector 104 configured to couple together. Each of the connectors 102, 104 is configured to terminate a conduit (e.g., a hose). The first and second connectors 102, 104 are configured to mate together along a longitudinal axis L to connect the conduits. In certain implementations, each of the connectors 102, 104 includes a valve 110, 112 that selectively closes the respective conduit when the connectors 102, 104 are disconnected. Mating the connectors 102, 104 opens the valves 110, 112 to fluidly connect the conduits.

The first connector 102 includes an inner body 106 surrounded by an outer nut 108. The inner body 106 carries the valve 110. The inner body 106 also defines one or more mounting stations 118 for retainers 120. In the example shown, the inner body 106 defines two opposing mounting stations 118, each extending along a portion of a circumference of the inner body 106. The outer nut 108 defines internal threading 114. The outer nut 108 also defining a respective groove 116 for each mounting station 118 defined by the inner body 106. Each groove 116 is located at an intermediate point along the threading 114. For example, the grooves 116 are cut or otherwise formed through the threading. Each groove 116 extends partially along an inner circumference of the outer nut 108. In certain examples, the groove 116 extends orthogonal to the longitudinal axis L. In certain examples, the threading 114 is angled relative to the groove 116.

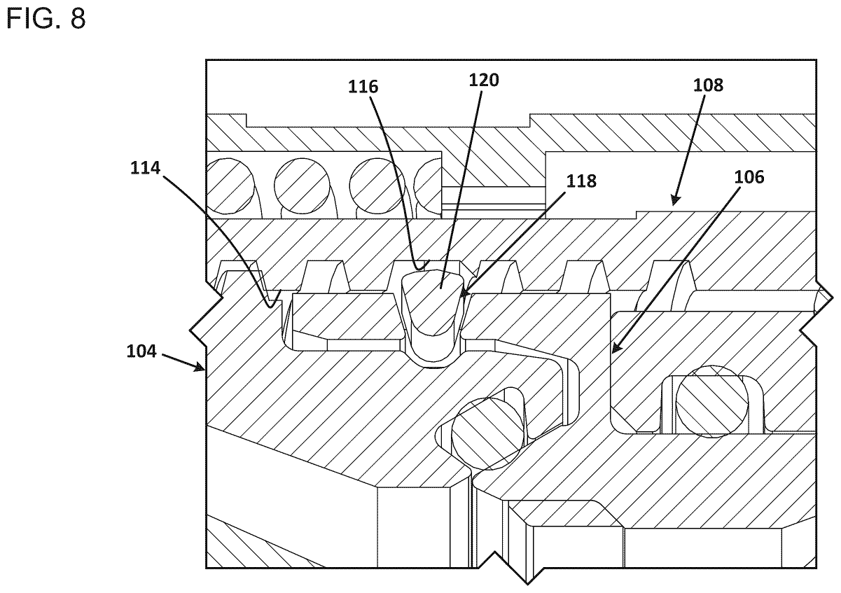

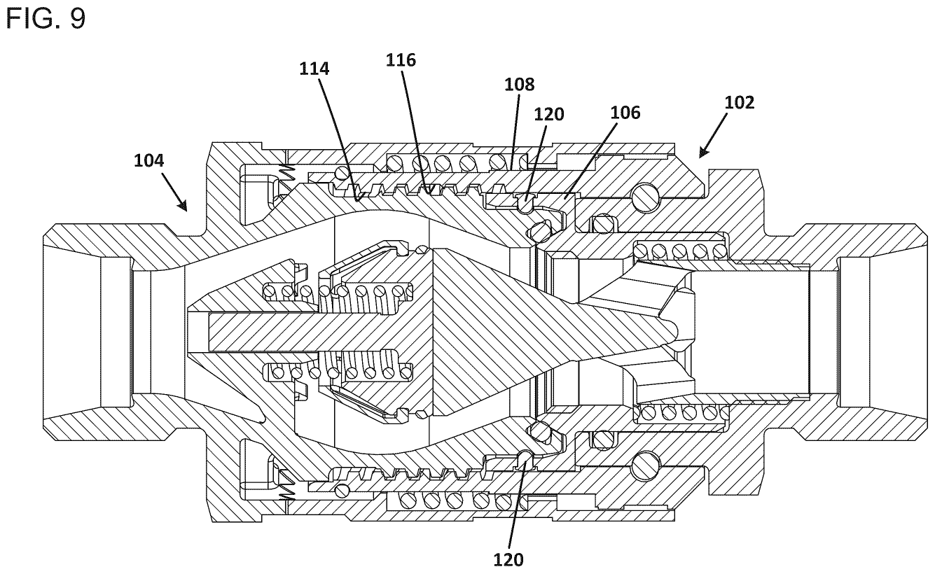

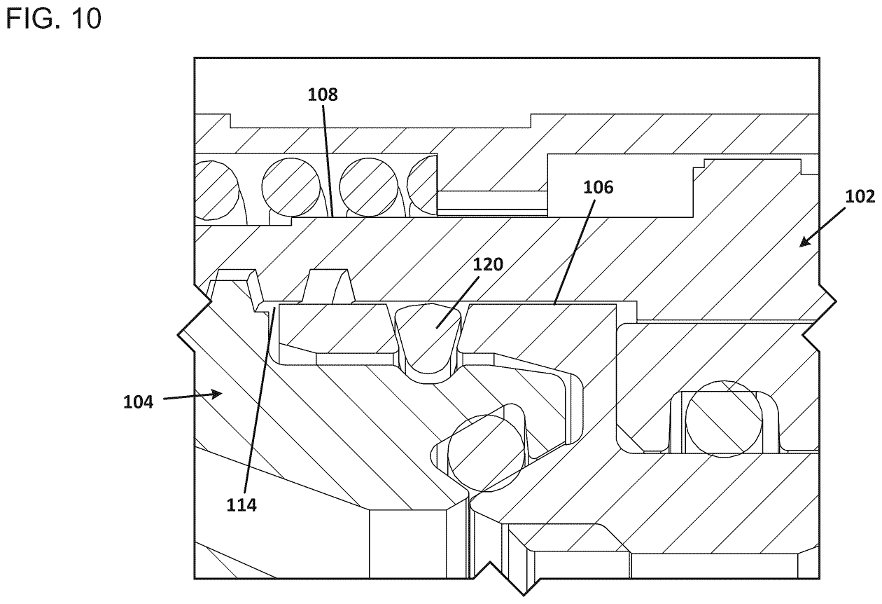

The inner body 106 is movable (e.g., slidable) along the longitudinal axis L relative to the outer nut 108. In certain implementations, the inner body 106 moves relative to the outer nut 108 between an initial position (e.g., see FIG. 1), a transition position (e.g., see FIG. 8), and an operation position (e.g., see FIGS. 9 and 10). In certain implementations, a biasing member (e.g., a spring) biases the inner body 106 towards the initial position. Accordingly, the inner body 106 is disposed in the initial position when the connectors 102, 104 are disconnected from each other. Each mounting station 118 is disposed to a first side of the groove 116 when the inner body 106 is disposed in the initial position. The inner body 106 moves from the initial position to the transition position against the bias of the biasing member while the connectors 102, 104 are initially connected, but before the valves 110, 112 begin to open.

Each mounting station 118 is aligned with the groove 116 when the inner body 106 is disposed in the transition position. Each retainer 120 of the first connector 102 snaps into a channel 128 of the second connector 104 when the outer nut 108 reaches the transition position. Accordingly, the first and second connectors are mechanically held together before the valves 110, 112 begin to open. The outer nut 108 is then threaded to the second connector 104, thereby moving the inner body 106 from the transition position towards the operation position. The valves 110, 112 open as the outer nut 108 threads to the second connector body 104. Each mounting station 118 is disposed to second side of the groove 116 when the inner body 106 is disposed in the operation position relative to the outer nut 108.

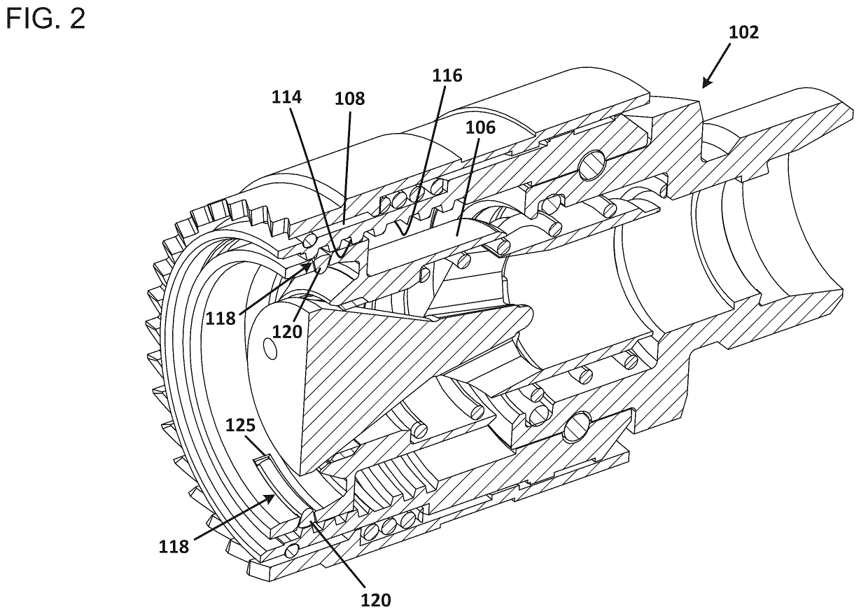

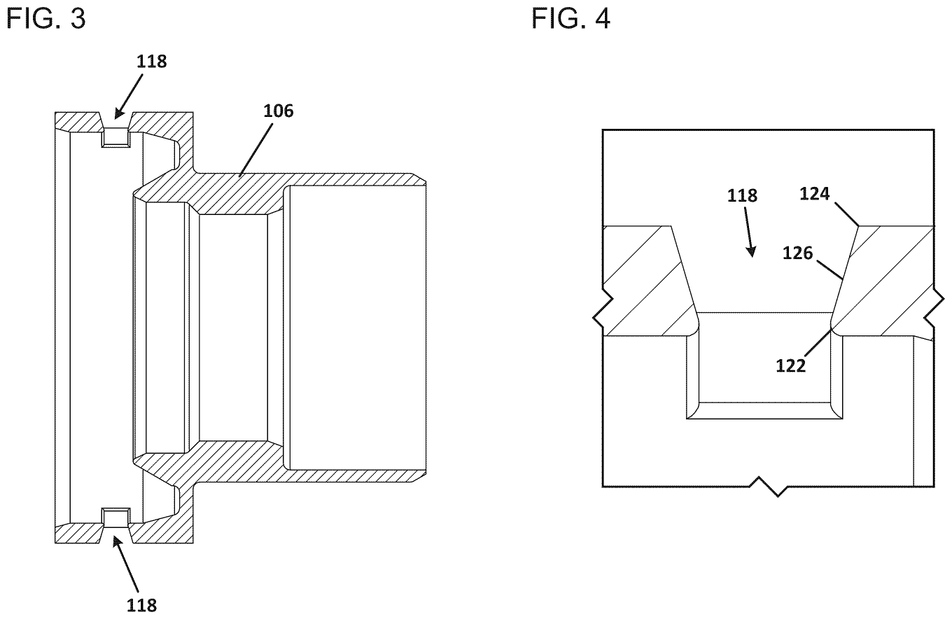

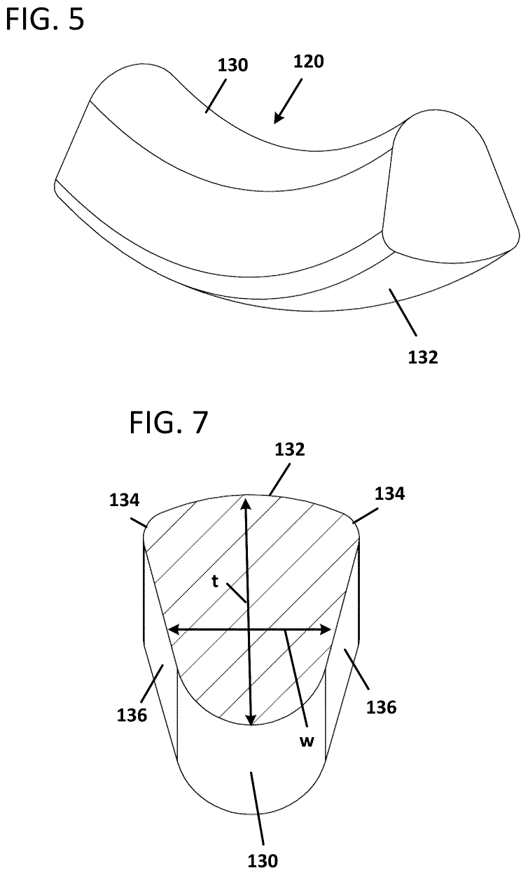

As shown in FIGS. 3 and 4, each mounting station 118 defines an aperture extending radially away from the longitudinal axis L from a first open end 122 to a second open end 124 (e.g., see FIGS. 3 and 4). The second open end 124 is larger than the first open end 122. The aperture also extends along part of the circumference of the inner body 106 between opposite circumferential ends 125 (e.g., see FIG. 2). Opposing sidewalls 126 of the aperture are spaced from each other along the longitudinal axis L and extend between the first and second open ends 122, 124. In certain examples, the sidewalls 126 angle away from each other as the sidewalls 126 extend from the first open end 122 towards the second open end 124.

A retainer 120 is disposed at the mounting station 118. In the example shown in FIG. 2, a respective retainer 120 is disposed at each mounting station 118. In certain examples, the retainer 120 is free-floating within the aperture. In certain examples, the retainer 120 is configured to move radially relative to the inner body 106 between a locking position and a releasing position. The retainer 120 is held in the locking position by the threading 114 of the outer nut 108 (e.g., see FIG. 10). The groove 116 along the internal threading 114 accommodates the radial movement of the retainer 120 to the releasing position (e.g., see FIG. 8).

In accordance with aspects of the disclosure, the retainer 120 has a non-uniform transverse cross-section. In certain implementations, the retainer 120 has a tapered transverse cross-sectional shape. In an example, the retainer 120 has a trapezoidal or rounded trapezoidal transverse cross-section. In certain examples, the retainer 120 extends along a height t between an inner surface 130 and an outer surface 132. The retainer 120 includes sides 136 extending between the inner and outer surfaces 130, 132. The inner surface 130 is configured to engage the channel 128 of the second connector 104 when the first and second connectors 102, 104 are mated. In certain examples, the inner surface 130 is more narrowly contoured than the outer surface 132. In certain examples, the sides 136 angle away from each other as they extend from the inner surface 130 towards the outer surface 132.

In certain implementations, the outer surface 132 is configured to slide past the threading 114 of the outer nut 108 without catching. In some examples, the outer surface 132 is flat. In other examples, the outer surface 132 has a gentle contour. In certain examples, corners 134 at opposite sides of the outer surface 132 are rounded to facilitate slipping past the threading 114.

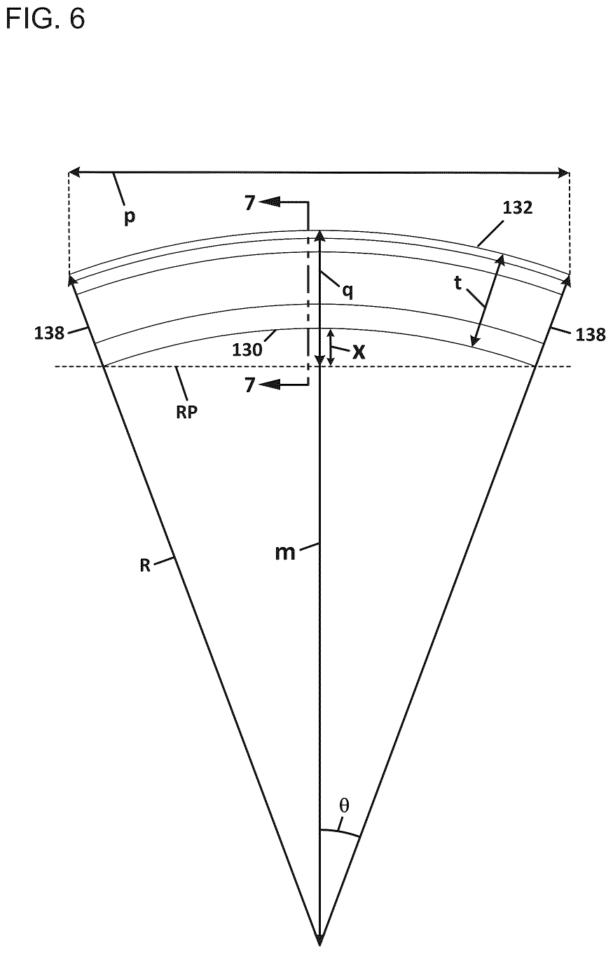

In certain implementations, the retainer 120 has an arc length p and a height t. In certain examples, the retainer 120 is contoured along the arc length p to generally match a circumference of the inner body 106. In certain examples, the inner surface 130 defines a concave contour along the arc length p while the outer surface 132 defines a convex contour along the arc length p (e.g., see FIG. 6). In certain examples, both the inner and outer surfaces 130, 132 define convex contours along a width w that is orthogonal to the arc length p (e.g., see FIG. 7). In certain examples, the retainer 120 is contoured along the arc length p to define a distance x between the inner surface 130 at a central location along the arc length p and a reference plane RP extending between the axial ends of the inner surface 130 (e.g., see FIG. 6). In certain examples, axial ends 138 of the retainer 120 extend between the inner surface 130 and the outer surface 132 at an angle θ from a midline m of the retainer 120.

In certain examples, the retainer 120 is contoured along the arc length p such that:

q=x+t=(R−t)(1−cos(θ))+t [1]

where q is the distance between the reference plane RP and the outer surface 132 at the midline m and R is the radius of the arc of the outer surface 132. Further, the retainer 120 is contoured along the arc length p such that:

p=2R*sin(θ). [2]

In certain implementations, the retainer 120 has a poka-yoke design relative to the mounting station 118. For example, the distance q of the retainer 120 may be longer than a width of the aperture at the mounting station 118 where the width extends along the longitudinal axis of the first connector 102. Accordingly, the retainer 120 cannot be assembled with a 90 degree tilt. Further, the width of the outer surface 132 of the retainer 120 is larger than a width of the first open end 122 of the mounting station aperture. Accordingly, the retainer 120 cannot be assembled upside down. Such a poka-yoke design inhibits the retainer 120 from being assembled in a way that would inhibit operation of the first connector 102 (e.g., inhibit sliding of the outer nut 108 relative to the inner body 106).

In certain implementations, the sidewalls 126 of the mounting station 118 are configured to facilitate radial movement of the retainer 120 relative thereto. In certain examples, the mounting station sidewalls 126 have a different angle compared to the sides 136 of the retainer 120. In certain examples, the difference in the angles allows the retainer 120 to be supported within the mounting station 118 at points of contact instead of along a majority of the sides. Accordingly, the retainer 120 need only overcome the friction at the points of contact to move from the locking position to the releasing position.

Examples of the invention can be found in the following Aspects of the Disclosure.

Aspect 1. A connector system comprising:
a first connector having a longitudinal axis, the first connector including an inner body surrounded by an outer nut, the inner body being movable relative to the outer nut along the longitudinal axis, the outer nut having internal threading, the internal threading defining a circumferential groove at an intermediate location along the internal threading, the inner body defining a mounting station; and
a retainer disposed at the mounting station of the inner body of the first connector, the retainer configured to move radially relative to the inner body of the first connector between a locking position and a releasing position, the retainer being held in the locking position by the internal threading of the outer nut, the groove along the internal threading accommodating movement of the retainer to the releasing position, and the retainer having a non-uniform transverse cross-section.

Aspect 2. The quick disconnect connector system of aspect 1, wherein the retainer has a length that extends partially along a circumference of the inner body, a width that extends along the longitudinal axis of the first connector, and a height that extends radially away from the longitudinal axis from a first end surface and to a second end surface, and wherein the first end surface is more narrowly contoured than the second end surface.

Aspect 3. The quick disconnect connector system of aspect 2, wherein the second end surface is planar.

Aspect 4. The quick disconnect connector system of aspect 2, wherein the second end surface is convex.

Aspect 5. The quick disconnect connector system of aspect 2, wherein corners of the second end surface are rounded.

Aspect 6. The quick disconnect connector system of aspect 2, wherein planar sides extend between the first and second end surfaces.

Aspect 7. The quick disconnect connector system of aspect 2, wherein the second end surface defines wings.

Aspect 8. The quick disconnect connector system of aspect 1, wherein the mounting station includes internal walls that support sides of the retainer when the retainer is disposed in the locking position, the internal walls being angled differently from the sides of the retainer.

Aspect 9. The quick disconnect connector system of aspect 1, wherein the groove extends orthogonal to the longitudinal axis; and wherein the internal threading is angled relative to the groove.

Aspect 10. The quick disconnect connector system of aspect 1, further comprising a second connector including a body carrying a second valve, the body of the second connector having external threading that fits with the internal threading of the outer nut of the first connector, the body of the second connector defining an outwardly-facing channel configured to receive the retainer when the body of the second connector is mated with the inner body of the first connector.

Aspect 11. A quick disconnect connector system comprising:
a first connector including an inner body extending along a longitudinal axis, the inner body defining a mounting station, the first connector also including an outer nut extending about the inner body, the outer nut defining a groove, the inner body being movable relative to the outer nut along the longitudinal axis between an initial position, a transition position, and an operation position, the mounting station being aligned with the groove when the inner body is disposed in the transition position, the mounting station being disposed to a first side of the groove when the inner body is disposed in the initial position, and the mounting station being disposed to an opposite, second side of the groove when the inner body is disposed in the operation position, the mounting station defining an aperture extending radially away from the longitudinal axis from a first open end to a second open end, the second open end being larger than the first open end.

Aspect 12. The quick disconnect connector system of aspect 11, further comprising:
a second connector defining a channel; and
a retainer disposed at the mounting station of the first connector, the retainer being configured to engage the channel of the second connector during mating of the first and second connectors.

Aspect 13. The quick disconnect connector system of aspect 12, wherein the retainer engages the channel when the outer nut is disposed in the transition position.

Aspect 14. The disconnect connector system of aspect 13, wherein the retainer continues to engage the channel as the outer nut moves between the transition position and the operating position.

Aspect 15. The disconnect connector system of aspect 13, wherein the retainer disengages from the channel when the outer nut moves from the transition position towards the initial position.

Aspect 16. The disconnect connector system of aspect 12, wherein the retainer having a non-uniform transverse cross-section.

Aspect 17. The disconnect connector system of aspect 16, wherein the retainer includes sides extending between a first end and a second end, the second end being wider than the first end.

Aspect 18. The disconnect connector system of aspect 17, wherein the sides are angled relative to each other.

Aspect 19. The disconnect connector system of aspect 17, wherein the sides are parallel to each other; and wherein the second end includes ledges extending outwardly beyond the sides.

Aspect 20. The disconnect connector system of aspect 17, wherein the second end defines a convex contact surface.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A connector system comprising:
a first connector having a longitudinal axis, the first connector including an inner body surrounded by an outer nut, the inner body being movable relative to the outer nut along the longitudinal axis, the outer nut having internal threading, the internal threading defining a circumferential groove at an intermediate location along the internal threading, the inner body defining a mounting station; and
a retainer disposed at the mounting station of the inner body of the first connector, the retainer configured to move radially relative to the inner body of the first connector between a locking position and a releasing position, the retainer being held in the locking position by the internal threading of the outer nut, the groove along the internal threading accommodating movement of the retainer to the releasing position, and the retainer having a non-uniform transverse cross-section.

2. The quick disconnect connector system of claim 1, wherein the retainer has a length that extends partially along a circumference of the inner body, a width that extends along the longitudinal axis of the first connector, and a height that extends radially away from the longitudinal axis from a first end surface and to a second end surface, and wherein the first end surface is more narrowly contoured than the second end surface.

3. The quick disconnect connector system of claim 2, wherein the second end surface is planar.

4. The quick disconnect connector system of claim 2, wherein the second end surface is convex.

5. The quick disconnect connector system of claim 2, wherein corners of the second end surface are rounded.

6. The quick disconnect connector system of claim 2, wherein planar sides extend between the first and second end surfaces.

7. The quick disconnect connector system of claim 2, wherein the second end surface defines wings.

8. The quick disconnect connector system of claim 1, wherein the mounting station includes internal walls that support sides of the retainer when the retainer is disposed in the locking position, the internal walls being angled differently from the sides of the retainer.

9. The quick disconnect connector system of claim 1, wherein the groove extends orthogonal to the longitudinal axis; and wherein the internal threading is angled relative to the groove.

10. The quick disconnect connector system of claim 1, further comprising a second connector including a body carrying a second valve, the body of the second connector having external threading that fits with the internal threading of the outer nut of the first connector, the body of the second connector defining an outwardly-facing channel configured to receive the retainer when the body of the second connector is mated with the inner body of the first connector.

11. A quick disconnect connector system comprising:
a first connector including an inner body extending along a longitudinal axis, the inner body defining a mounting station, the first connector also including an outer nut extending about the inner body, the outer nut defining a groove, the inner body being movable relative to the outer nut along the longitudinal axis between an initial position, a transition position, and an operation position, the mounting station being aligned with the groove when the inner body is disposed in the transition position, the mounting station being disposed to a first side of the groove when the inner body is disposed in the initial position, and the mounting station being disposed to an opposite, second side of the groove when the inner body is disposed in the operation position, the mounting station defining an aperture extending radially away from the longitudinal axis from a first open end to a second open end, the second open end being larger than the first open end.

12. The quick disconnect connector system of claim 11, further comprising:
a second connector defining a channel; and
a retainer disposed at the mounting station of the first connector, the retainer being configured to engage the channel of the second connector during mating of the first and second connectors.

13. The quick disconnect connector system of claim 12, wherein the retainer engages the channel when the outer nut is disposed in the transition position.

14. The disconnect connector system of claim 13, wherein the retainer continues to engage the channel as the outer nut moves between the transition position and the operating position.

15. The disconnect connector system of claim 13, wherein the retainer disengages from the channel when the outer nut moves from the transition position towards the initial position.

16. The disconnect connector system of claim 12, wherein the retainer having a non-uniform transverse cross-section.

17. The disconnect connector system of claim 16, wherein the retainer includes sides extending between a first end and a second end, the second end being wider than the first end.

18. The disconnect connector system of claim 17, wherein the sides are angled relative to each other.

19. The disconnect connector system of claim 17, wherein the sides are parallel to each other; and wherein the second end includes ledges extending outwardly beyond the sides.

20. The disconnect connector system of claim 17, wherein the second end defines a convex contact surface.
